(19) United States
(12) Patent Application Publication
(10) Pub. No.: US 2024/0020093 A1
(43) Pub. Date: Jan. 18, 2024

(54) COMPUTE-IN-MEMORY SUPPORT FOR DIFFERENT DATA FORMATS

(71) Applicant: Intel Corporation, Santa Clara, CA (US)

(72) Inventors: Richard Dorrance, Hillsboro, OR (US); Deepak Dasalukunte, Beaverton, OR (US); Renzhi Liu, Portland, OR (US); Hechen Wang, Portland, OR (US); Brent Carlton, Portland, OR (US)

(21) Appl. No.: 18/477,716

(22) Filed: Sep. 29, 2023

(51) Int. Cl. G06F 7/483

(52) U.S. Cl. CPC G06F 7/483

(57) ABSTRACT

Systems, apparatuses and methods include technology that identifies workload numbers associated with a workload. The technology converts the workload numbers to block floating point numbers based on a division of mantissas of the workload numbers into sub-words and executes a compute-in memory operation based on the sub-words to generate partial products.

### TECHNICAL FIELD

Examples generally relate to compute-in-memory (CiM) architectures. In particular, examples include circuits to convert different data formats into formats compatible with CiM architectures to generate partial products, and circuits to generate a final output based on the partial products.

### BACKGROUND

Machine learning (e.g., neural networks, deep neural networks, etc.) workloads may include a significant amount of operations. For example, machine learning workloads may include numerous nodes that each execute different operations. Such operations may include General Matrix Multiply operations, multiply-accumulate operations, etc. The operations may consume memory and processing resources to execute, and occur in different data formats.

### BRIEF DESCRIPTION OF THE DRAWINGS

The various advantages of the embodiments will become apparent to one skilled in the art by reading the following specification and appended claims, and by referencing the following drawings, in which:

FIG. 1 is an example of a CiM architecture according to an embodiment;

FIGS. 2A, 2B and 2C are examples of a conversion process according to an embodiment;

FIG. 3 is a flowchart of an example of a method of executing CiM operations according to an embodiment;

FIG. 4 is an example of a time sequencing process according to an embodiment;

FIG. 5 is an example of a redundancy scheme with a high-dynamic range (HDR) ADC approach according to an embodiment;

FIG. 6 is an example of a redundancy scheme with Booth encoding approach according to an embodiment;

FIG. 7 is an example of a CiM prefetch process according to an embodiment;

FIG. 8 is an example of a CiM operation process according to an embodiment;

FIG. 9 is an example of a CiM DAC load process according to an embodiment;

FIG. 10 is an example of a CiM partial load process according to an embodiment;

FIG. 11 is an example of a CiM addition and accumulation according to an embodiment;

FIG. 12 is an example of a CiM memory storage process according to an embodiment;

FIG. 13 is an example of a memory storage architecture according to an embodiment;

FIG. 14 is a diagram of an example of a computation enhanced computing system according to an embodiment;

FIG. 15 is an illustration of an example of a semiconductor apparatus according to an embodiment;

FIG. 16 is a block diagram of an example of a processor according to an embodiment; and

FIG. 17 is a block diagram of an example of a multi-processor based computing system according to an embodiment.

### DESCRIPTION OF EMBODIMENTS

Compute-in-Memory (CiM) architectures (e.g., in-memory compute cores) may closely relate the processing and storage capabilities of a computer system into a single, memory-centric computing structure. In CiM, computations may be performed directly in memory rather than moving data between the memory and a computation unit or processor. CiMs may accelerate machine learning workloads such as artificial intelligence (AI) and/or deep neural networks (DNN) workloads. The mapping of workloads onto hardware (e.g., CiMs) plays a crucial role in defining the performance and energy consumption in such applications. CIMs may also be referred to as IMCCs.

A “weight stationary” dataflow may be adopted and stores weights into a memory location and stays stationary for further accesses. That is, the weights stay constant in a memory location until all of an input feature map's data is provided to a core and the corresponding outputs have been computed by the core. The outputs computed during a given phase of computation in the CIM may be “partial” outputs (referred to as partial sums) of a computation. The partial sums may be stored and retrieved later, to accumulate with further sets of partial sums of data that will be computed during later phases of the computation. That is, a complete operation may comprise several phases of calculations generating partial sums, retrieval of any previously stored partial sums, accumulation of newly calculated partial sums with any retrieved partial sums and finally, storage of latest (accumulated) partial sums that are the final output.

CiM accelerators have shown great potential in efficient acceleration of DNNs. Analog CiMs may achieve superior computation density and efficiency in performance metrics of Tera Operations per Second (TOPS)/mm² and TOPS/W by using a C-2C capacitor ladder-based charge domain that includes a multi-bit computation and recombination. Such analog CiM solutions may only provide for limited-bit, fixed-point computation. Some inference applications properly operate based on the dynamic range of floating-point (FP). Even when the dynamic range of floating point is not mandatory for proper operation, quantization to extended fixed-point results in accuracy loss. Quantization-aware retraining may recover some, if not all, of the accuracy loss but at great cost (e.g., weeks to months of retraining penalties), preventing rapid deployment. Furthermore, neural network training operates based on the dynamic range of floating point in order to converge.

A difference between “extended” fixed-point operations and fixed-point hardware is the native hardware support. For example, if physically, 8-bit hardware to execute 8-bit multiplications and additions (e.g., fixed point operations) is only available, then a program or sequence of operations may be built to use the 8-bit hardware to execute 16-bit multiplications and additions (e.g., extended fixed point operations). So the “extended” fixed-point extends the precision range of the physical hardware to a precision that is not natively supported by the underlying hardware.

Examples enable different data formats (e.g., extended fixed-point (FXP) and floating-point (FP)) compute within a CiM array. Examples add digital circuits along a periphery of the CiM array to sequence and accumulate FXP partial products, dynamically convert FP into a Block FP format to leverage FXP compute and/or FP compute, and employ a redundancy and/or error correction scheme to prevent the exponential amplification of bit errors due variation and/or noise within the analog compute during a mantissa renormalization step.

Block FP formats may leverage FXP and/or regular FP compute depending on the underlying hardware characteristics. For example, in embedded C programming, if a user specifies a FP multiply, a complier may identify the available hardware of a CPU of a computing device. If an FP unit exists in the CPU, then one instruction is produced. If no FP unit exists in the CPU, then a longer list of fixed-point instructions (e.g., either in FXP instructions or regular FP instructions) are produced to generate an equivalent mathematical operation.

Some examples include analog in-memory computing. Analog in-memory computing can provide superior performance enhancements as opposed to other designs to achieve both high throughput and high efficiency. Existing, other implementations have been limited to limited precision fixed-point compute. Doing so limits the range of AI and/or machine learning (ML) models that can be deployed on the existing implementations, and degrades and/or prevents the existing implementations from effectively executing AI/ML model training. Examples provide a method to support extended fixed-point and floating-point compute on CiM architectures (e.g., design for fixed-point compute) while addressing the accuracy problem for analog computing.

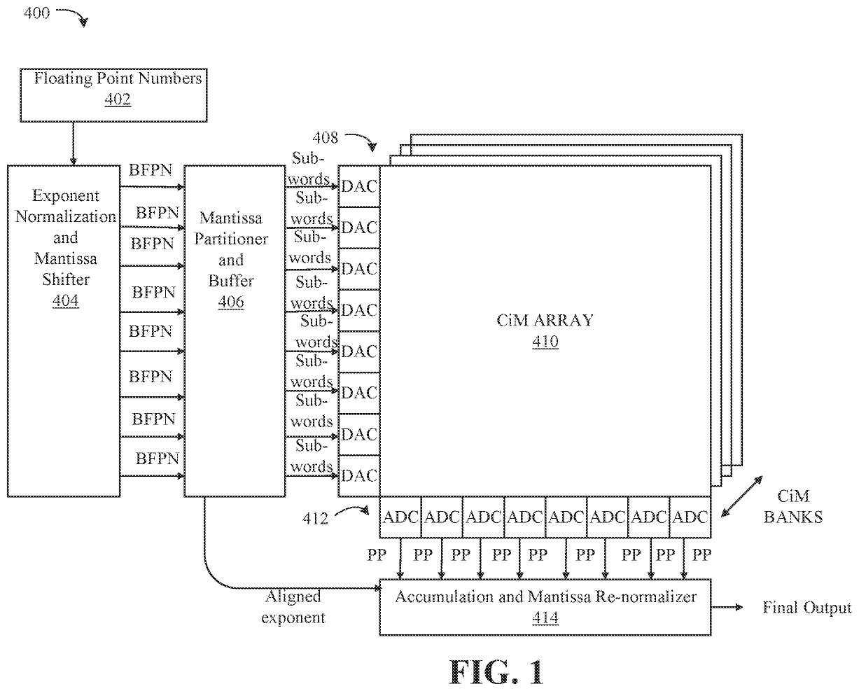

Turning now to FIG. 1, a CiM architecture 400. In the CiM architecture 400, a signal flow FP computation with CiM is illustrated. Initially, FP numbers 402 are provided. It will be understood that other types of data formats (that would otherwise be unsupported for CiM operations without the examples provided herein) may be included rather than the FP numbers 402. For example, rather than FP numbers 402, FXP numbers may be included and adjusted.

Notably, for the FXP numbers, examples may omit an exponent normalization process discussed below. Examples assume that the exponent of an FXP number is 2 N (or another provided fixed-point length). Block FP processes produce a fixed-point vector all with the same exponent to simplify the accumulation step. The exponent is therefore assumed to be the same for all FXP numbers, and therefore exponent normalization may be bypassed.

Initially, the FP numbers 402 are provided to an exponent normalization and mantissa shifter 404 to convert FP numbers 402 to block FP numbers (BFPN). The exponent normalization and mantissa shifter 404 converts the FP numbers 402 (e.g., workload floating point numbers) into Block FP numbers. In a block FP, all of the numbers have an independent mantissa but share a common exponent in each data block. Doing so allows the full data width within different processing blocks to be efficiently utilized. If the FP numbers 402 (e.g., vector of inputs) is already in Block FP format or replaced with integers (e.g., extended FXP), the exponent normalization and mantissa shifter 404 can be bypassed.

Block FP may be employed rather than plain FP due to the normalization steps that regular FP processes may execute. In plain FP, multiplication operations may be relatively straightforward: 1) multiply mantissas of FP numbers together; 2) add the exponents of the of FP numbers together to generate a combined exponent; and 3) execute a normalization step to adjust the combined exponent. Addition operations in regular FP may include: 1) alignment of exponents of two FP numbers to generate a final exponent, and shifting the mantissas of the two FP numbers; 2) followed by adding the two FP numbers together; and 3) a more costly normalization operation (relative to the multiplication operations) to correct the final exponent. For example, suppose that the operation is “0.5-0.4999999,” then 0.0000001 may be output. The process to do so includes a large adjustment to the exponent at the end to renormalize the exponent. Block FP executes a significant amount of the aforementioned overhead initially, and allows multiple addition and multiplication operations to be executed prior to the exponent re-normalization operation being executed.

In order to convert the FP numbers 402 to the BFPNs, the exponent normalization and mantissa shifter 404 identifies a maximum exponent value from all exponents of the FP numbers 402. The FP numbers 402 may be in a vector format. In some examples, the exponent normalization and mantissa shifter 404 may include a comparator tree that may identify the maximum exponent value from all exponents of the FP numbers 402 in the digital domain.

The exponent normalization and mantissa shifter 404 may determine how many right bit shifts of each mantissa are required to align a corresponding exponent of the FP numbers 402 with the maximum exponent value. That is, a first exponent of a first original FP number of the FP numbers 402 may be left bit shifted (increased in magnitude) until the value of the first exponent is equivalent to the maximum exponent value. In correspondence with the left bit shifts of the first exponent, a first mantissa of the first FP number may be right shifted to generate a shifted first FP number. The shifted first FP number includes the shifted first exponent and shifted first mantissa. The shifted first FP number is approximately equivalent to the first original FP number. Some examples identify an adjustment to the value of the first exponent (e.g., a lower exponent value) to adjust the value of the first exponent to be equal to the maximum exponent value. For example, the value of the first exponent may be subtracted from the maximum exponent value to identify a difference between the first and maximum exponent values. The first exponent may be left shifted based on the difference. The first mantissa of the first FP number may be right shifted (e.g., becomes smaller) based on the difference (e.g., right shifted a number of times that corresponds to the difference). For example, the first mantissa may be right shifted a number of times based on a value of the difference. The remaining mantissas of the FP numbers 402 may be right shifted based on differences between an associated exponent value and maximum exponent value.

The maximum exponent value is saved as the “Block” or “Aligned” Exponent and sent and/or routed to accumulation and mantissa re-normalizer 414 (e.g., a final compute stage). Thus, BFPNs may be provided to a mantissa partitioner and buffer 406. Each BFPN may correspond to one of the floating point numbers 402, has a same maximum exponent value and may have mantissa different from mantissas of the other BFPNs.

The mantissa partitioner and buffer 406 may receive the BFPNs. Depending on the FP formats used, and the dimensions of the digital-to-analog converters (DACs) 408 and CiM word lengths, the compute will need to be broken up into a series of partial products and sequenced in time. The mantissa partitioner and buffer 406 performs that partitioning and acts as a buffer for the time sequencing (e.g., generates sub-words that are output at different times).

In a first operation, the mantissa partitioner and buffer 406 breaks the mantissa of each corresponding BFPN of the BFPNs into an “X” number of N-bit sub-words, and appends a corresponding sign bit of the corresponding BFPN to the sub-words. For multiple sub-words, the partial products will need to be sequenced in time. Doing so can permit mixed precision compute (e.g., integer (INT)×FP, FP×INT and/or FP×FP INT×INT).

The sub-words may be provided to the DACs 408. The DACs 408 may convert the sub-words from a digital domain to an analog domain. The CiM array 410 may operate in the analog domain. The CiM array 410 may execute calculations and/or operations entirely in the CiM array 410. The CiM array 410 may receive the analog sub-words to generate partial products that include exponents and mantissas. For example, the CiM array 410 may use mantissa compute using CiM. Within the CiM operation, all of the partial products for the mantissa compute are performed. CiM is used and is treated as normal INT-INT compute rather than a FLOAT-FLOAT compute. Thus, floating point format numbers may execute on integer-based hardware.

ADCs 412 may receive the partial products (PPs) and convert the PPs from the analog domain to the digital domain. The accumulation and mantissa re-normalizer 414 receives the PPs in the digital format.

The accumulation and mantissa re-normalizer 414 re-normalizes the PPs. That is, after the PP compute, all of the ADC 412 outputs need to be aligned and accumulated to reassemble the mantissas. The accumulated PPs may be combined from adjacent ADCs as would occur in a digital array multiplier.

After the final accumulation, mantissa re-normalization may be executed. For example, a mantissa of the final accumulation is left shifted until the largest magnitude bit (e.g., MSB) of the mantissa is “1.” The number of shifts is the “correction” exponent. The final exponent is calculated by adding the “aligned” exponent above (the maximum exponent value) to an ADC exponent (e.g., exponent pair) stored for each ADC of the ADCs 412, and subtracting the “correction” exponent. Each ADC 412 output (e.g., “column” or PP) has an associated ADC exponent that is determined from an operation executed on the sub-words and is stored in the CiM array 410. For example, a first ADC of the ADCs 412 may provide a first PP of the PPs. The CiM array 410 may have generated the first PP based on an operation executed on first and second sub-words of the sub-words. The operation executed on the first and second sub-words may also resulted in a first exponent being generated. The first exponent is stored as a first ADC exponent. Thus, the first PP may output the first PP in association with the first ADC exponent. The exponents of different PPs may be accumulated, and the mantissas of the PPs may also be accumulated. The accumulated mantissas and exponents may then be “renormalized” as described above.

A final output may thus be generated. The final output may be a final exponent (renormalized exponent), associated mantissa (renormalized mantissa) and sign bit. The CiM array 410 may perform various neural network operations, include general matrix multiply.

It is worthwhile to note that the various components may be implemented in hardware circuitry and/or configurations. For example, the exponent normalization and mantissa shifter 404, the mantissa partitioner and buffer 406, the CiM array 410, the DAC s 408, the ADCs 412 and accumulation and mantissa re-normalizer 414 may be implemented in hardware implementations that may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), general purpose microprocessor or combinational logic circuits, and sequential logic circuits or any combination thereof. The configurable or fixed-functionality logic can be implemented with complementary metal oxide semiconductor (CMOS) logic circuits, transistor-transistor logic (TTL) logic circuits, or other circuits.

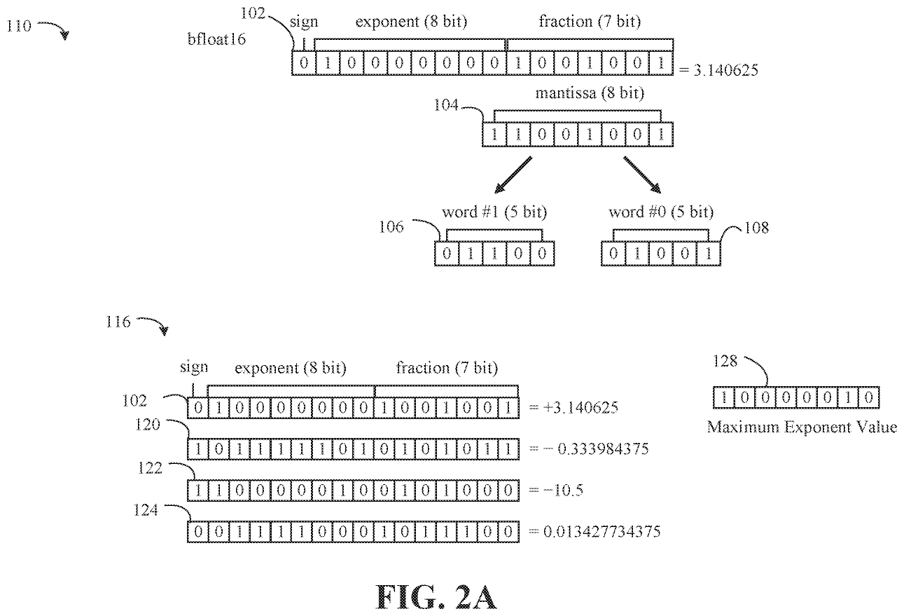

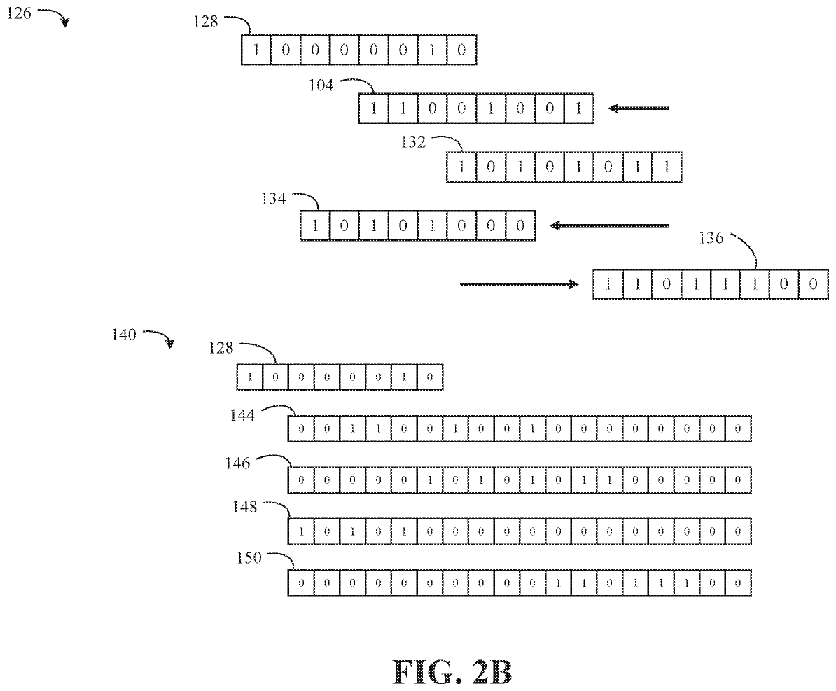

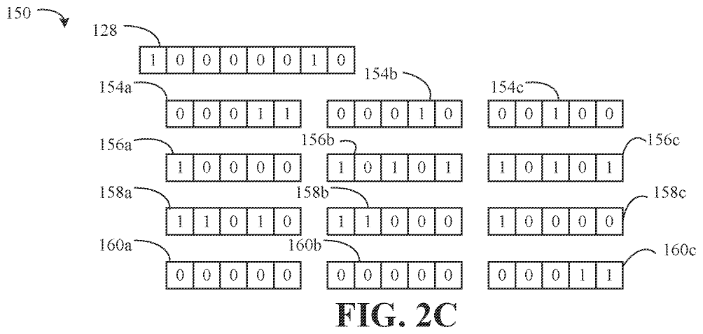

FIGS. 2A-2C illustrate a conversion process 110 to convert a FP computation into a block FP computation executable on integer-hardware. The process 110 may generally be implemented with the embodiments described herein, for example, the CiM architecture 400 (FIG. 1) already discussed.

FP computation is split into two components: the 1) exponent and 2) mantissa, with a final renormalization step to re-range the exponent and mantissa as discussed above. In existing implementations, re-ranging prevents efficient implementations of FP using CiM. Examples herein may efficiently re-range the exponent as described below.

The process 110 pre-aligns a “block” of FP numbers 116 such that the FP numbers 116 have the same exponent and can be stored as an integer exponent and an integer vector of the FP mantissas. Operations on the exponent (digitally) and mantissa (CiM) portions may be executed separately using integer arithmetic.

In order to execute the above and in-memory compute, examples can include a C-2C-based analog CiM (with a sign-magnitude format) as part of a memory array, such as the CiM array 410 (FIG. 1). The mantissa of FP data is partitioned into sub-words with an appended sign-bit, and the exponent is stored digitally. For example, a first FP number 102 is illustrated at the top of FIG. 2A. The first FP number 102 includes a sign bit, 8 exponent bits and 7 fraction bits. A FP may be converted to a decimal format following Equation 1 when the exponent is 8-bits:

(−1)^{s}×(1+Fraction)×2^{exp-127} Equation 1

In the fraction, the most significant bit is “−1” and the least significant bit is “−7” with the other bits ranging in-between (e.g., ranging between 2⁻¹ to 2⁻⁷ if a value of one is in a bit position). For example, the first FP number 102 includes “0” as the sign bit, an exponent value of 2⁷ (128) and a fraction of 2⁻¹+2⁻⁴+2⁻⁷ (0.5703125). Placing these values into Equation 1 results in the following (−1)⁰×(1+0.5703125)×2¹²⁸⁻¹²⁷=1×1.5703125×2¹=3.140625. Equation 1 may be adjusted to various bit formats. For example, in many instances, the bias (127 in Equation 1) for a floating-point exponent is (2^{N-1})−1. So for a 5-bit bias in the half-precision format, the bias would be calculated as follows: (2⁵⁻¹)−1=(2\hat{ }4)−1=16−1=15.

To convert the fraction into a first mantissa 104, a value of 1 is added to the fraction as the most significant bit (e.g., a zero bit position is added and has a value of one), to represent the constant “1” in Equation 1. Thus, the first mantissa 104 is now 8 bits. The first mantissa 104 may be divided into two sub-words 106, 108, with the sign bit of “0” appended to the sub-words as the most-significant bit. The sign bit value of “0” is the same as the value of the sign bit of the first FP number 102. The above division is exemplary, and it will be understood that the first mantissa 104 may be divided into a different number of words and may adopt various bit lengths.

As illustrated in FP numbers 116, an input vector of FP values will undergo normalization to have the exponents of first-fourth FP numbers 102, 120, 122, 124 normalized and mantissas shifted. Each of the first-fourth FP numbers 102, 120, 122, 124 has a similar FP format. That is, in each of the first-fourth FP numbers 102, 120, 122, 124, a most-significant bit is a “sign” bit, the following 8 bits are exponent bits, and the 7 least significant bits are the fraction bits. The first FP number 102 has an exponent of 10000000. The second FP number 120 has an exponent of 01111101, the third FP number 122 has an exponent of 10000010 and the fourth FP number 124 has an exponent of 01111000. Thus, the largest exponent is 10000010 from the FP number 122, and is set as a maximum exponent value 128.

As illustrated, the second FP number 120 has a value of −0.333984375, the third FP number 122 has a value of −10.671875 and the fourth FP number 124 has a value of 0.013427734375. For example, for the third FP number 122, the number is 1100000100101000. In this example, the sign is 1, and thus the third FP number 122 is negative. The Exponent is calculated as “10000010=130−127=3”. The fraction is calculated is “0101000,” so the mantissa=10101000. Normalized, the fraction value is equal to 1.3125. Thus, the final value is −1*2³*1.3125=−10.5.

The first, second and fourth FP numbers 102, 120, 124 will be normalized to the maximum exponent value 128 (exponent) of the third FP number 122. The second FP number 120 need not be normalized as the second FP number 120 already has the maximum exponent value 128 set as the exponent of the second FP number 120.

Turning now to FIG. 2B, first-fourth mantissas 104, 132, 134, 136 of the first-fourth FP numbers 102, 120, 122, 124 respectively are shown. The fractions from the first-fourth FP numbers 102, 120, 122, 124 have a “one” padded to the fraction as the most significant bit to obtain the first-fourth mantissas 104, 132, 134, 136 that are equivalent to the fractions of the first-fourth FP numbers 102, 120, 122, 124 plus one.

As shown in adjusted operation 140, the first-fourth mantissas 104, 132, 134, 136 may be adjusted to adjusted mantissas 144, 146, 148, 150 based on a difference between the maximum exponent value 128 and an exponent value of a corresponding one of the first-fourth FP numbers 102, 120, 122, 124. For example, a first exponent of the first FP number 102 is 10000000. A bit difference between the first exponent (10000000) and the maximum exponent value 128 (10000010) is 00000010 or 2. Thus, the first mantissa 104 is right shifted twice to first adjusted mantissa 144.

A bit difference between the second exponent value of the second FP number 120 and the maximum exponent value 128 is 10000010−01111101=00000101=2²+2⁰=5. Thus, the second mantissa 132 is right shifted 5 times to generate second adjusted mantissa 146.

A bit difference between the third exponent value of the third FP word 122 and the maximum exponent value 128 is zero, since the maximum exponent value 128 was selected from the third FP word 122. Thus, the third mantissa 134 is not right shifted at all to generate third adjusted mantissa 148.

A bit difference between the fourth exponent value of the fourth FP 124 and the maximum exponent value 128 is 10000010−01111000=00001010=2¹+2³=10. Thus, the fourth mantissa 136 is right shifted 10 times to generate fourth adjusted mantissa 150.

Turning now to FIG. 2C, the first-fourth adjusted mantissas 144, 146, 148, 150 are divided into smaller portions (e.g., sub-words). The first adjusted mantissa 144 is divided into three first sub-words 154a-154c that each include the corresponding sign bit from the first FP number 102. The second adjusted mantissa 146 is divided into three second sub-words 156a-156c that each include the corresponding sign bit from the second FP number 120. The third adjusted mantissa 148 is divided into three third sub-words 158a-158c that each include the corresponding sign bit from the third FP number 122. The fourth adjusted mantissa 150 is divided into three fourth sub-words 160a-160c that each include the corresponding sign bit from the fourth FP number 124. The fourth adjusted mantissa 150 may be truncated such that some of the lower significant bits are not included. Doing so has little impact on accuracy since the lower significant bits (e.g., “ . . . 111 . . . ”) have insignificant values. The first sub-words 154a-154c, second sub-words 156a-156c, third sub-words 158a-158c and fourth sub-words 160a-160c are then sent to a DACs for the CiM operations.

The exponent may be forwarded to a partial sum accumulator to calculate the final exponent and renormalize the mantissa (as described above with respect to FIG. 1). This operation may be pipelined to maintain CiM throughput (unlike bit-serial compute) with minimal additional hardware (one digital bit shifter per DAC, one digital accumulator per ADC, and one exponent adder per ADC). The result is 10-100× better energy and area efficiency for FP compute vs traditional digital implementations.

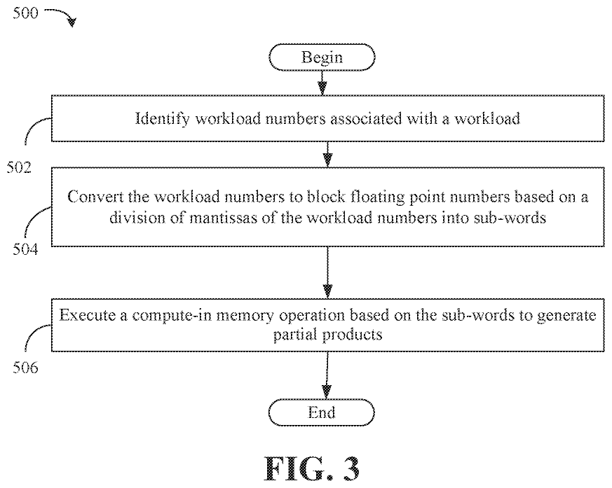

FIG. 3 shows a method 500 of executing CiM operations based on floating point numbers according to embodiments herein. The method 500 may generally be implemented with the embodiments described herein, for example, the CiM architecture 400 (FIG. 1) and process 110 (FIGS. 2A-2C) already discussed. More particularly, the method 500 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, general purpose microprocessor or combinational logic circuits, and sequential logic circuits or any combination thereof. The configurable or fixed-functionality logic can be implemented with CMOS logic circuits, TTL logic circuits, or other circuits.

For example, computer program code to carry out operations shown in the method 500 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 502 identifies workload numbers associated with a workload. Illustrated processing block 504 converts the workload numbers to block floating point numbers based on a division of mantissas of the workload numbers into sub-words. Illustrated processing block 506 executes a compute-in memory operation based on the sub-words to generate partial products.

The converting the workload numbers to block floating point numbers comprises appending sign bits of the workload numbers to the sub-words. The converting the workload numbers to block floating point numbers further comprises identifying a maximum exponent value from exponents of the workload numbers, identifying a lower exponent value from the exponents that is smaller than the maximum exponent value, and identifying an adjustment to the lower exponent value to adjust the lower exponent value to be equal to the maximum exponent value. The identifying the adjustment to the lower exponent value includes subtracting the lower exponent value from the maximum exponent value to identify a difference. The converting the workload numbers to block numbers comprises identifying a lower mantissa from the mantissas that is associated with the lower exponent value, and right shifting the lower mantissa based on the difference. The partial product includes a first partial product and a second partial product, and the method further comprises accumulating the partial products to generate an accumulated mantissa, renormalizing the accumulated mantissa to generate a final mantissa by a left-shift of the accumulated mantissa a number of times until a largest magnitude bit of the accumulated mantissa has a predetermined value, determining a final exponent based on an exponent value associated with the partial products, the maximum exponent value and the number of times, associating the final exponent with the final mantissa to generate the final output, and accumulating a most significant bit of the first partial product with a least significant bit of the second partial product during accumulation of the first partial product and the second partial product.

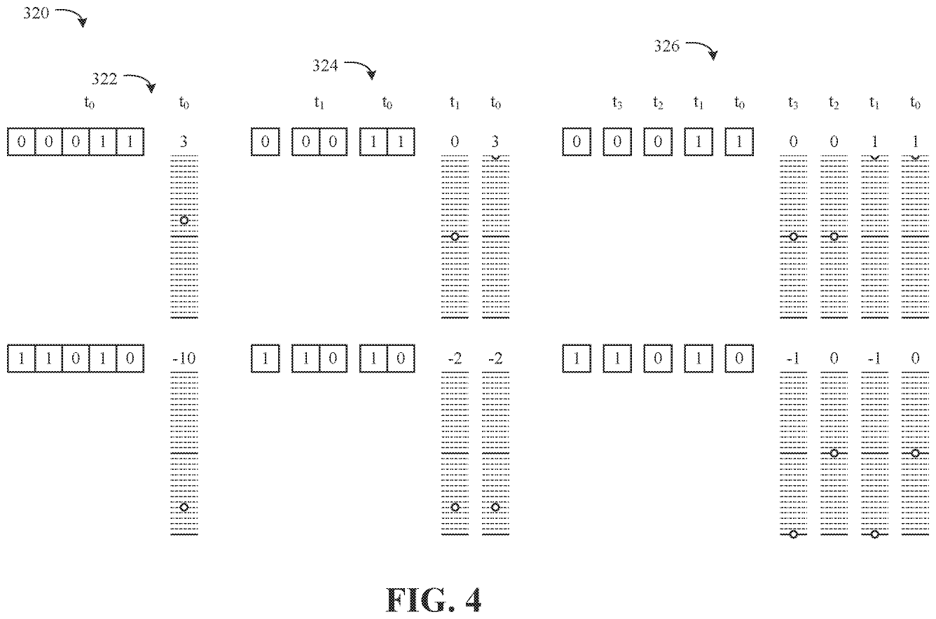

FIG. 4 illustrates a time sequencing process 320 of a partial product compute. The time sequencing process 320 may generally be implemented with the embodiments described herein, for example, the CiM architecture 400 (FIG. 1), process 110 (FIGS. 2A-2C) and/or method 500 (FIG. 3) already discussed. In some examples, the time sequencing process 320 may be implemented by the mantissa partitioner and buffer 406 (FIG. 1).

At timing diagram 322, a 5-bit computation is to be executed. A 5-bit DAC provides 5 bits at time T₀. That is, different 5-bit elements are provided to the CiM array as single codewords having values of 3 and −10.

At diagram 324, the DAC may output up to 3-bits at a time. Therefore, in order to provide the 5-bit codewords (00011 and 11010), the DAC provides data at time T₁ and T₀. Partial products are calculated at times T₁ (e.g., 3 and −2) and T₀ (e.g., 0 and −2) and accumulated after the entire 5-bit codewords are received. At timing diagram 326, the DAC may be a Ternary DAC that provides a +1, −1, or a 0 at each time cycle. Therefore, the sign bit may be included in each bit value. The DAC provides data at times T₃−T₀ and calculates four partial products that are combined when all four-bits are received.

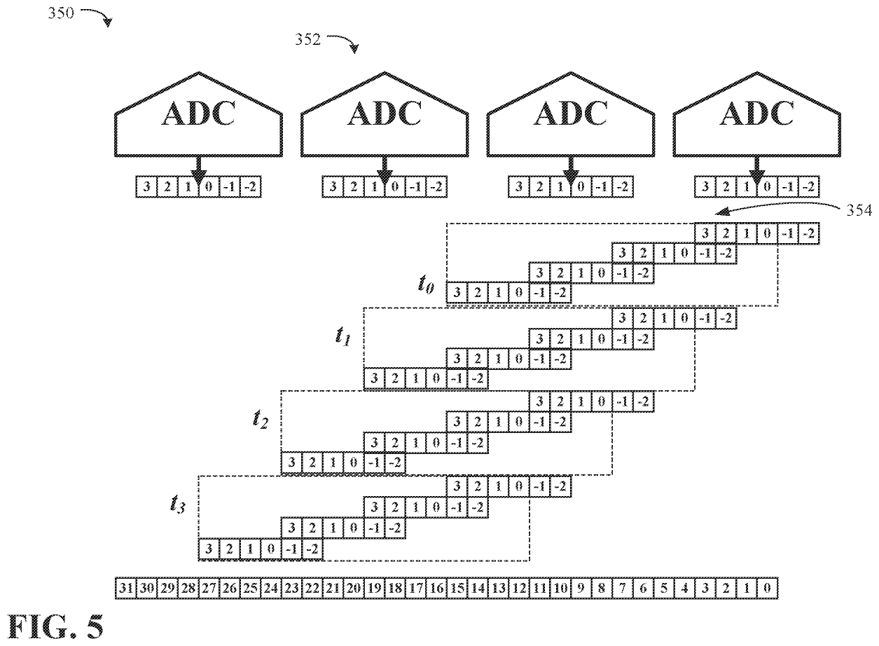

FIG. 5 illustrates a redundancy scheme 350 with an HDR-ADC approach. The redundancy scheme 350 may generally be implemented with the embodiments described herein, for example, the CiM architecture 400 (FIG. 1), process 110 (FIGS. 2A-2C), method 500 (FIG. 3) and/or time sequencing process 320 (FIG. 4) already discussed. The redundancy scheme may be implemented by the ADCs 412 (FIG. 1) and/or the accumulation and mantissa re-normalizer 414.

Nonidealities and noise in analog computing may end up reducing the accuracy in implementations of sixteen plus bit integer MACs by leveraging multiple 8-bit partial products. Some level of redundancy or error correction may be implemented between the partial products to reduce and/or minimize error. In floating point, the redundancy or error correction is particularly applicable for the most significant bit (MSB) word when the result is near zero, as a plus or minus one (LSB) error can be exponentially amplified by the renormalization of the mantissa (e.g., when the mantissa is left shifted to move lower significant bits into greater significant bit positions to place a value of “one” in the most significant bit position) during correction of the final exponent value. Doing so may be an issue even assuming the ADC has ideal, error-free conversion. This is because the lack of ADC bits for conversion is essentially a digital truncation on “missing” LSB bits (e.g., LSB bits that are not included in the computation or truncated). For example, a 64-dimensional analog MAC computation with an 8-bit input activation and 8-bit weights is presented, and the output activation is quantized by an 8-bit ADC. In a counterpart full-digital implementation, such an arrangement would result in an ideal 8+8+6=22-bit after digital computation. Meanwhile, this specific analog implementation essentially has a truncation of 14 bits on the LSB part by using an 8-bit ADC.

One way to address the above is with higher precision ADCs to resolve sub-LSB bits to minimize noise and truncation error. To minimize power and area, while maximizing throughput, High Dynamic Range ADCs 352 may be used. The High Dynamic Range ADCs 352 may output different values for different positions, where the bit positions are denoted with −2 to 3. The redundancy is achieved by overlapping the MSB and LSB of the magnitude of adjacent partial products during accumulation. For example, on the far right at position 354, the MSBs 3 and 2 of a first ADC overlap with the LSBs −2 and −1 and are accumulated together. The overlap may be repeated between outputs from adjacent ADCs.

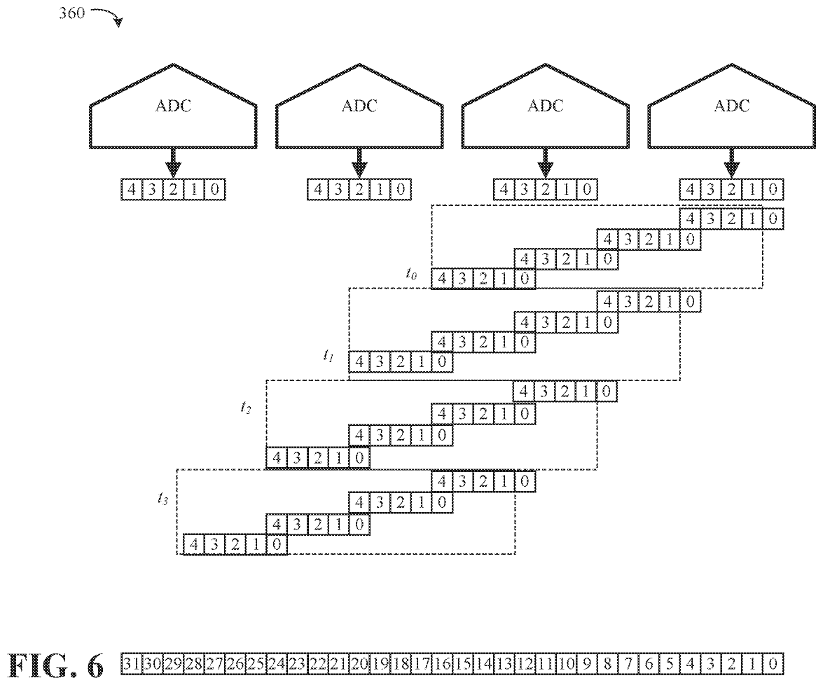

FIG. 6 illustrates a redundancy scheme 360 with a modified radix-2^{N} Booth encoding. The redundancy scheme 360 may generally be implemented with the embodiments described herein, for example, the CiM architecture 400 (FIG. 1), process 110 (FIGS. 2A-2C), method 500 (FIG. 3) and/or time sequencing process 320 (FIG. 4) already discussed. The redundancy scheme may be implemented by the ADCs 412 (FIG. 1) and/or the accumulation and mantissa re-normalizer 414 (FIG. 1).

Using no wider than requisite ADCs (e.g., 8-bits), is to implement a modified radix-2^{N} Booth encoding of the partial products with redundancy for a sign-magnitude data format. The redundancy is achieved by overlapping the MSB and LSB of the magnitude of adjacent partial products. Hence the mantissa of a FP 32 number may be encoded in four 8-bit sign-magnitude partial products (7+6+6+6=25-bit>24-bit mantissa). FP 16 may be encoded in two 8-bit sign-magnitude partial products (7+6=13-bit>11-bit mantissa). Bfloat16 may be encoded in two 8-bit sign-magnitude partial products (7+6=13-bit>8-bit mantissa). Given the truncation by the ADC, a Booth-encoded sign-digit-based conditional probability (BSCP) method may be used to minimize the mean square error (MSE). With a sign-magnitude representation in a Booth Encoding, the result may be similar to a redundant encoding scheme. The redundancy allows enough “room” between valid numbers to enable error correction.

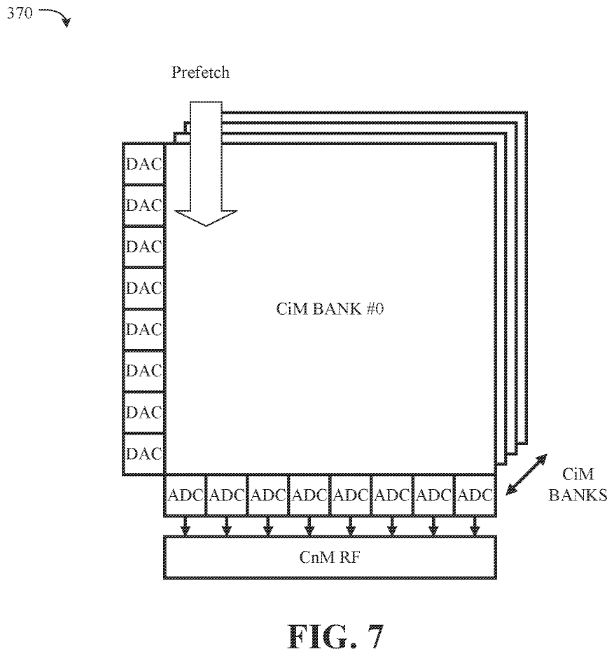

FIG. 7 illustrates a CiM prefetch process 370. The CiM prefetch process 370 may generally be implemented with the embodiments described herein, for example, the CiM architecture 400 (FIG. 1), process 110 (FIGS. 2A-2C), method 500 (FIG. 3), time sequencing process 320 (FIG. 4), redundancy scheme 350 (FIG. 5) and/or redundancy scheme 360 (FIG. 6) already discussed. The CiM prefetch process 370 prefetches data to be stored into the CiM bank as indicated by the prefetch arrow. That is physical values are loaded into the CiM bank (e.g., an SRAM array).

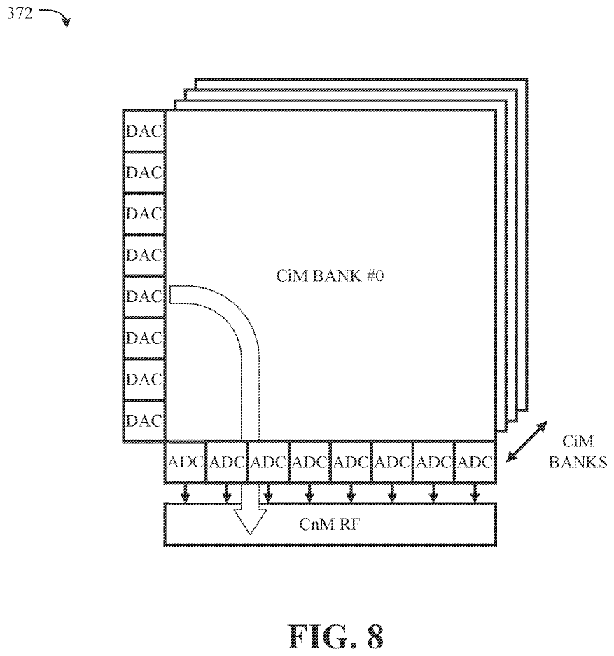

FIG. 8 illustrates a CiM operation process 372. The CiM operation process 372 may generally be implemented with the embodiments described herein, for example, the CiM architecture 400 (FIG. 1), process 110 (FIGS. 2A-2C), method 500 (FIG. 3), time sequencing process 320 (FIG. 4), redundancy scheme 350 (FIG. 5), redundancy scheme 360 (FIG. 6) and/or CiM prefetch process 370 (FIG. 7) already discussed. The CiM operation process 372 executes a CiM matrix vector multiplication where inputs from the DACs are being processed in the CiM bank, output through ADCs and then stored into a register (e.g., CnM RF).

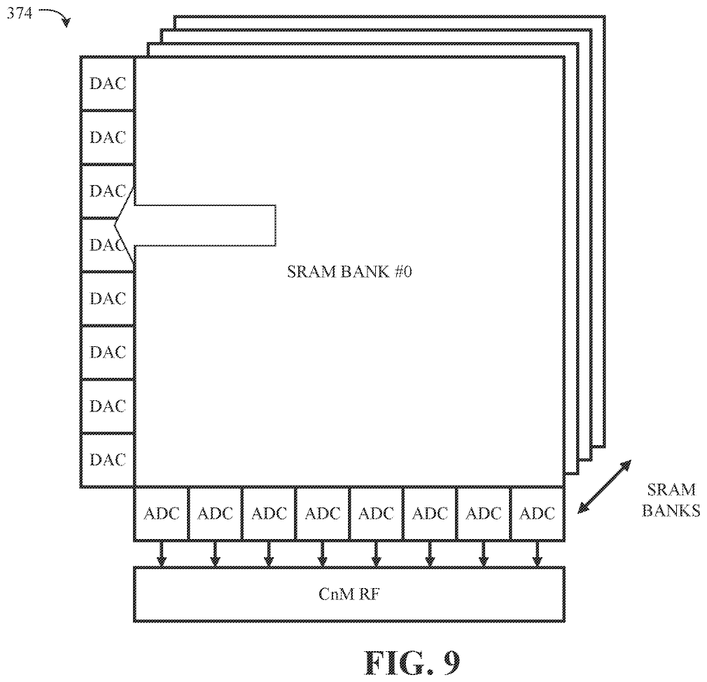

FIG. 9 illustrates a CiM DAC load process 374 to retrieve data from memory. The CiM DAC load process 374 may generally be implemented with the embodiments described herein, for example, the CiM architecture 400 (FIG. 1), process 110 (FIGS. 2A-2C), method 500 (FIG. 3), time sequencing process 320 (FIG. 4), redundancy scheme 350 (FIG. 5), redundancy scheme 360 (FIG. 6), CiM prefetch process 370 (FIG. 7) and/or CiM operation process 372 (FIG. 8) already discussed. The CiM architecture executes a CiM data load. For example, the CiM architecture may load CiM data buffer from a memory address into DACs.

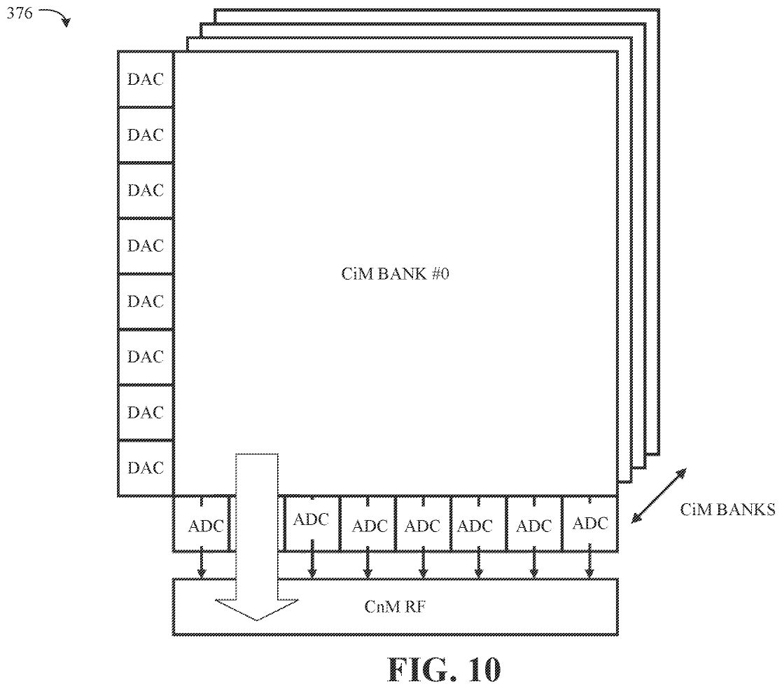

FIG. 10 illustrates a CiM partial load process 376. The CiM partial load process 376 may generally be implemented with the embodiments described herein, for example, the CiM architecture 400 (FIG. 1), process 110 (FIGS. 2A-2C), method 500 (FIG. 3), time sequencing process 320 (FIG. 4), redundancy scheme 350 (FIG. 5), redundancy scheme 360 (FIG. 6), CiM prefetch process 370 (FIG. 7), CiM operation process 372 (FIG. 8) and/or CiM DAC load process 374 (FIG. 9) already discussed. The partial load process 376 executes a CnM data load of a partial result, converts the partial result into the digital domain from the analog domain and stores the digital partial result into a memory register file.

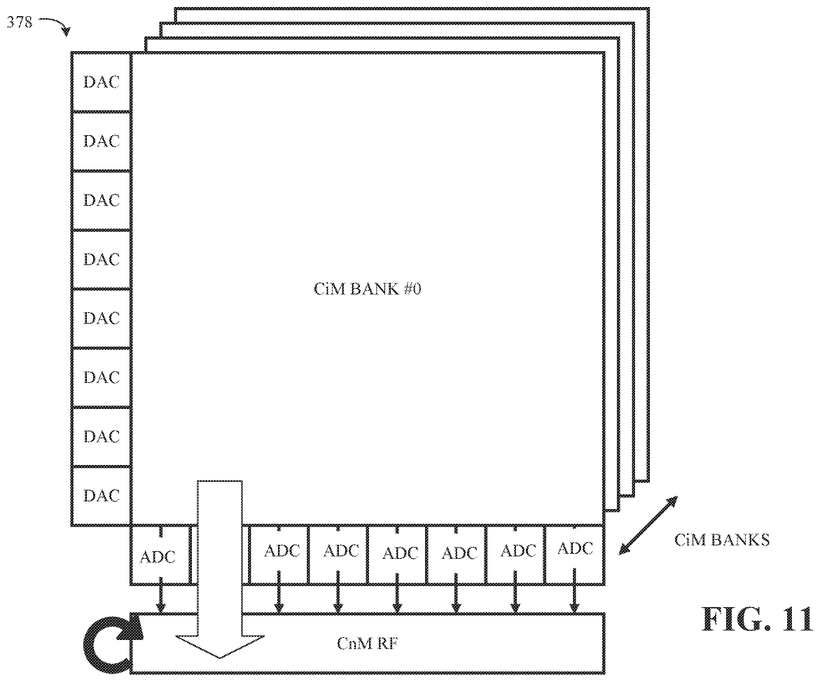

FIG. 11 illustrates a CiM addition and accumulation process 378. The CiM addition and accumulation process 378 may generally be implemented with the embodiments described herein, for example, the CiM architecture 400 (FIG. 1), process 110 (FIGS. 2A-2C), method 500 (FIG. 3), time sequencing process 320 (FIG. 4), redundancy scheme 350 (FIG. 5), redundancy scheme 360 (FIG. 6), CiM prefetch process 370 (FIG. 7), CiM operation process 372 (FIG. 8), CiM DAC load process 374 (FIG. 9) and/or CiM partial load process 376 (FIG. 10) already discussed. The CiM addition and accumulation process 378 executes a data load. In this example, the CiM addition and accumulation process 378 retrieves data from the CiM bank #0, accumulates a partial product and adds the partial to another partial product stored in a memory register file (CnM RF).

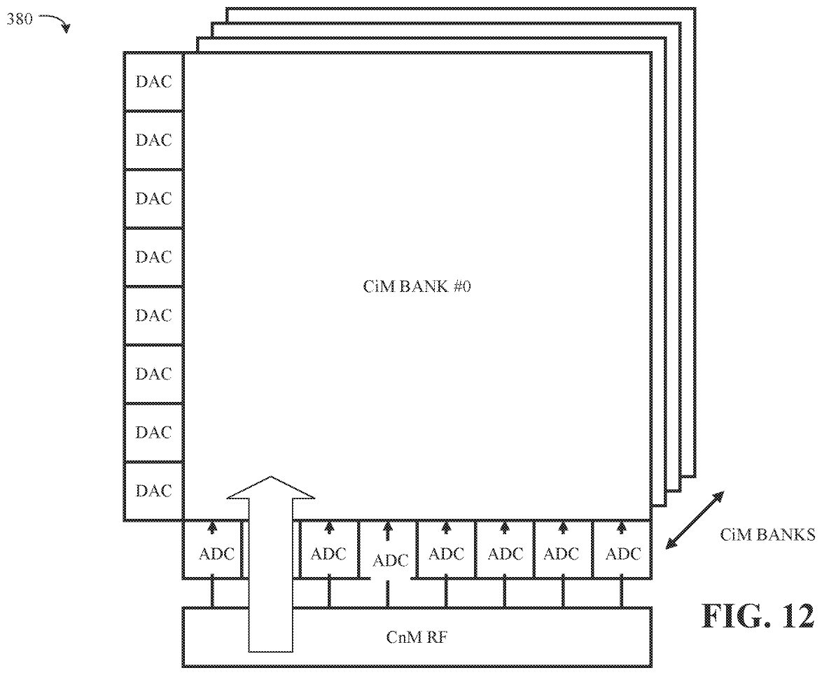

FIG. 12 illustrates a CiM memory storage process 380. The CiM memory storage process 380 may generally be implemented with the embodiments described herein, for example, the CiM architecture 400 (FIG. 1), process 110 (FIGS. 2A-2C), method 500 (FIG. 3), time sequencing process 320 (FIG. 4), redundancy scheme 350 (FIG. 5), redundancy scheme 360 (FIG. 6), CiM prefetch process 370 (FIG. 7), CiM operation process 372 (FIG. 8), CiM DAC load process 374 (FIG. 9), CiM partial load process 376 (FIG. 10) and/or CiM addition and accumulation process 378 (FIG. 11) already discussed. The CiM architecture moves data from the accumulator into the memory banks of the CiM bank. Data is loaded from the memory register file to the CiM bank #0.

The aforementioned CiM prefetch process 370 (FIG. 7), CiM operation process 372 (FIG. 8), CiM DAC load process 374 (FIG. 9), CiM partial load process 376 (FIG. 10), CiM addition and accumulation process 378 (FIG. 11) and/or CiM memory storage process 380 (FIG. 12) may be combined to execute various operations together. For example, multiplication, accumulation, matrix, vector-vector and matrix-matrix operations at different precisions may be supported. For example, weights may be loaded into a CiM bank with a prefetch, inputs may be loaded into the DAC, CiM may be executed and the corresponding PPs stored into a register file, switch CiM banks to execute another operation and store partial results into the register file, re-load the PPs into the CiM to execute other operations, and so forth.

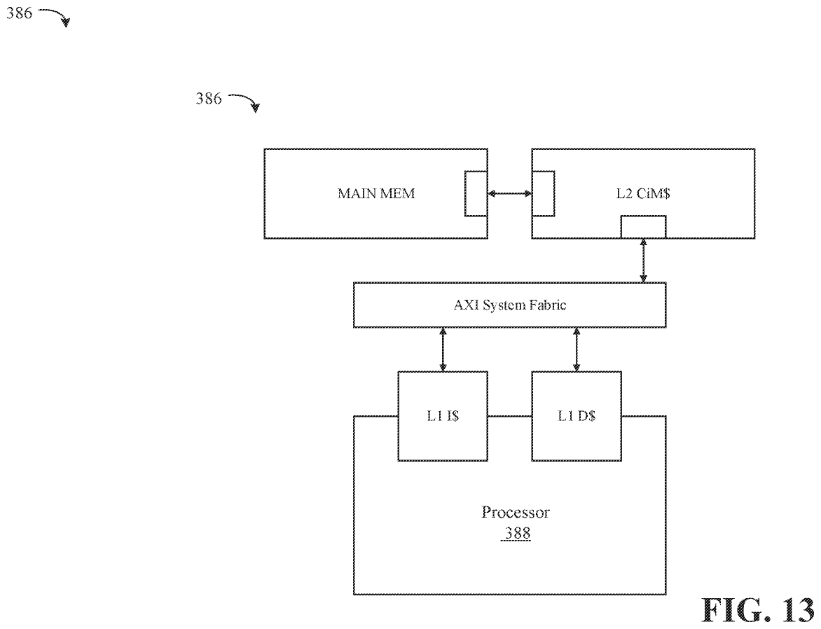

FIG. 13 illustrates a memory storage architecture 386. The memory storage architecture 386 may generally be implemented with the embodiments described herein, for example, the CiM architecture 400 (FIG. 1), process 110 (FIGS. 2A-2C), method 500 (FIG. 3), time sequencing process 320 (FIG. 4), redundancy scheme 350 (FIG. 5), redundancy scheme 360 (FIG. 6), CiM prefetch process 370 (FIG. 7), CiM operation process 372 (FIG. 8), CiM DAC load process 374 (FIG. 9), CiM partial load process 376 (FIG. 10), CiM addition and accumulation process 378 (FIG. 11) and/or CiM memory storage process 380 (FIG. 12) already discussed. In the memory storage architecture 386, data is stored into an L2 cache (e.g., executes CiM operations) and may be further processed at a processor 388.

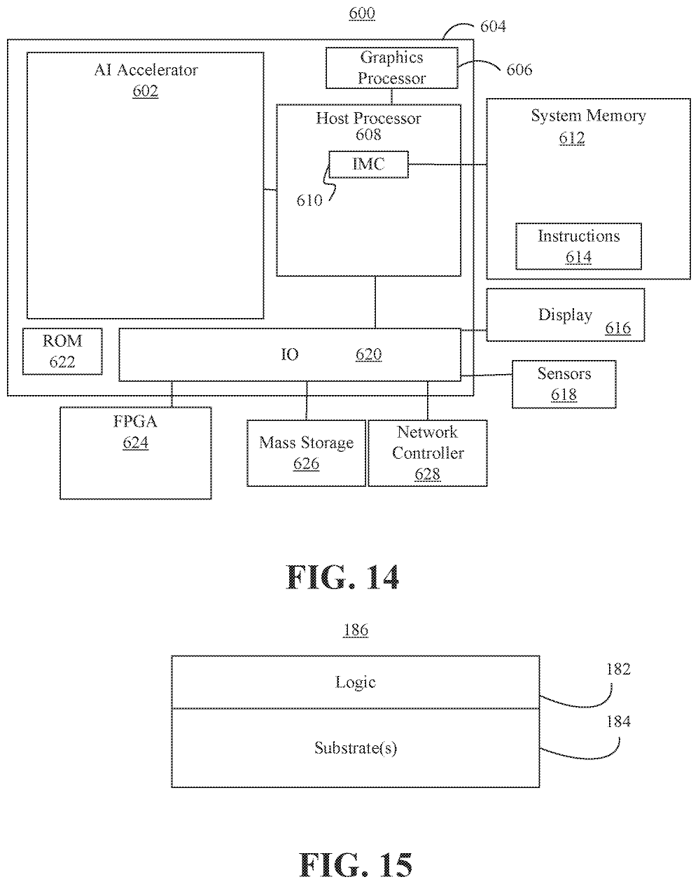

Turning now to FIG. 14, a computation enhanced computing system 600 is shown. The computation enhanced computing system 600 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot, manufacturing robot, autonomous vehicle, industrial robot, etc.), edge device (e.g., mobile phone, desktop, etc.) etc., or any combination thereof. In the illustrated example, the computing system 600 includes a host processor 608 (e.g., CPU) having an integrated memory controller (IMC) 610 that is coupled to a system memory 612.

The illustrated computing system 600 also includes an input output (IO) module 620 implemented together with the host processor 608, the graphics processor 606 (e.g., GPU), ROM 622, and AI accelerator 602 on a semiconductor die 604 as a system on chip (SoC). The illustrated 10 module 620 communicates with, for example, a display 616 (e.g., touch screen, liquid crystal display/LCD, light emitting diode/LED display), a network controller 628 (e.g., wired and/or wireless), FPGA 624 and mass storage 626 (e.g., hard disk drive/HDD, optical disk, solid state drive/SSD, flash memory). The IO module 620 also communicates with sensors 618 (e.g., video sensors, audio sensors, proximity sensors, heat sensors, etc.).

The SoC 604 may further include processors (not shown) and/or the AI accelerator 602 dedicated to artificial intelligence (AI) and/or neural network (NN) processing. For example, the SoC 604 may include vision processing units (VPUs,) and/or other AI/NN-specific processors such as the AI accelerator 602, etc. In some embodiments, any aspect of the embodiments described herein may be implemented in the processors, such as the graphics processor 606 and/or the host processor 608, and in the accelerators dedicated to AI and/or NN processing such as AI accelerator 602 or other devices such as the FPGA 624. In this particular example, the AI accelerator 602 may include a structure substantially similar to the CiM architecture 400 (FIG. 1) to process FP numbers and FXP numbers.

The graphics processor 606, AI accelerator 602 and/or the host processor 608 may execute instructions 614 retrieved from the system memory 612 (e.g., a dynamic random-access memory) and/or the mass storage 626 to implement aspects as described herein. In some examples, when the instructions 614 are executed, the computing system 600 may implement one or more aspects of the embodiments described herein. For example, the computing system 600 may implement one or more aspects of the examples described herein, for example, the CiM architecture 400 (FIG. 1), process 110 (FIGS. 2A-2C), method 500 (FIG. 3), time sequencing process 320 (FIG. 4), redundancy scheme 350 (FIG. 5), redundancy scheme 360 (FIG. 6), CiM prefetch process 370 (FIG. 7), CiM operation process 372 (FIG. 8), CiM DAC load process 374 (FIG. 9), CiM partial load process 376 (FIG. 10), CiM addition and accumulation process 378 (FIG. 11) and/or CiM memory storage process 380 (FIG. 12) and/or memory storage architecture 386 (FIG. 13) already discussed. The illustrated computing system 600 is therefore considered to be memory and performance-enhanced at least to the extent that the computing system 600 may execute machine learning operations.

FIG. 15 shows a semiconductor apparatus 186 (e.g., chip, die, package). The illustrated apparatus 186 includes one or more substrates 184 (e.g., silicon, sapphire, gallium arsenide) and logic 182 (e.g., transistor array and other integrated circuit/IC components) coupled to the substrate(s) 184. In an embodiment, the apparatus 186 is operated in an application development stage and the logic 182 performs one or more aspects of the embodiments described herein. For example, the CiM architecture 400 (FIG. 1), process 110 (FIGS. 2A-2C), method 500 (FIG. 3), time sequencing process 320 (FIG. 4), redundancy scheme 350 (FIG. 5), redundancy scheme 360 (FIG. 6), CiM prefetch process 370 (FIG. 7), CiM operation process 372 (FIG. 8), CiM DAC load process 374 (FIG. 9), CiM partial load process 376 (FIG. 10), CiM addition and accumulation process 378 (FIG. 11) and/or CiM memory storage process 380 (FIG. 12) and/or memory storage architecture 386 (FIG. 13) already discussed. The logic 182 may be implemented at least partly in configurable logic or fixed-functionality hardware logic. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

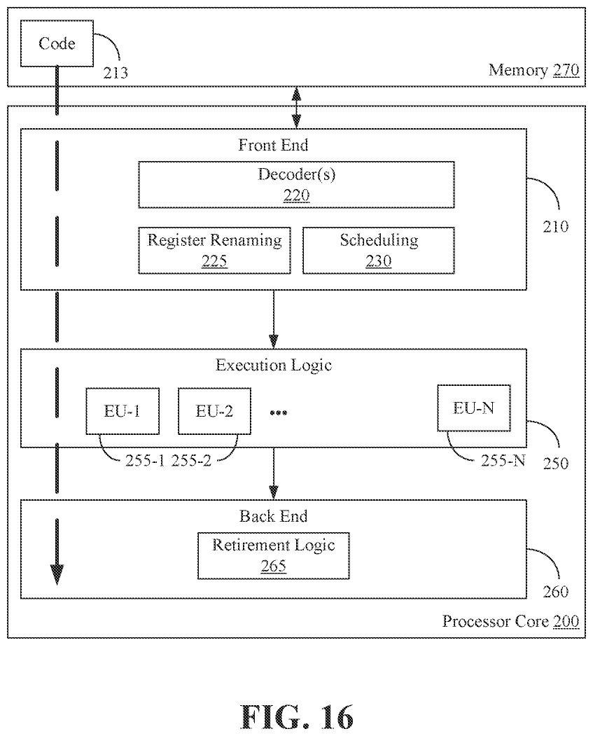

FIG. 16 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 15, a processing element may alternatively include more than one of the processor core 200 illustrated in FIG. 15. The processor core 200 may be a single-threaded core or, for at least one embodiment, the processor core 200 may be multithreaded in that it may include more than one hardware thread context (or “logical processor”) per core.

FIG. 16 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, the CiM architecture 400 (FIG. 1), process 110 (FIGS. 2A-2C), method 500 (FIG. 3), time sequencing process 320 (FIG. 4), redundancy scheme 350 (FIG. 5), redundancy scheme 360 (FIG. 6), CiM prefetch process 370 (FIG. 7), CiM operation process 372 (FIG. 8), CiM DAC load process 374 (FIG. 9), CiM partial load process 376 (FIG. 10), CiM addition and accumulation process 378 (FIG. 11) and/or CiM memory storage process 380 (FIG. 12) and/or memory storage architecture 386 (FIG. 13) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include several execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 16, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

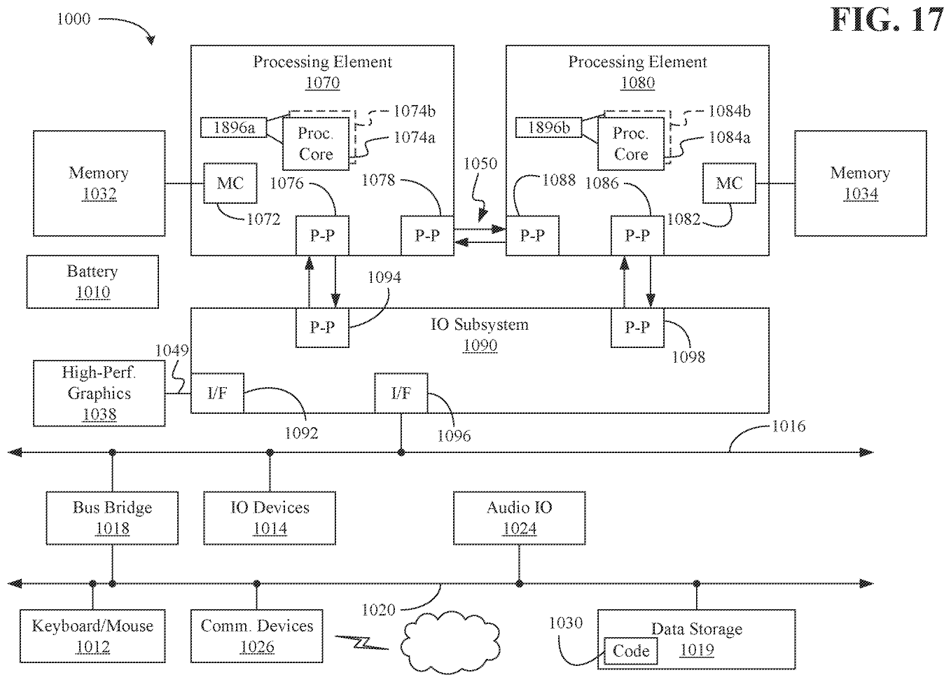

Referring now to FIG. 17, shown is a block diagram of a computing system 1000 embodiment in accordance with an embodiment. Shown in FIG. 17 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood any or all the interconnects illustrated in FIG. 17 may be implemented as a multi-drop bus rather than point-to-point interconnect.

As shown in FIG. 17, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner like that discussed above in connection with FIG. 16.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 17, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 17, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 17, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the one or more aspects of such as, for example, the CiM architecture 400 (FIG. 1), process 110 (FIGS. 2A-2C), method 500 (FIG. 3), time sequencing process 320 (FIG. 4), redundancy scheme 350 (FIG. 5), redundancy scheme 360 (FIG. 6), CiM prefetch process 370 (FIG. 7), CiM operation process 372 (FIG. 8), CiM DAC load process 374 (FIG. 9), CiM partial load process 376 (FIG. 10), CiM addition and accumulation process 378 (FIG. 11) and/or CiM memory storage process 380 (FIG. 12) and/or memory storage architecture 386 (FIG. 13) already discussed. Further, an audio I/O 1024 may be coupled to second bus 1020 and a battery 1010 may supply power to the computing system 1000.

Note that other embodiments are contemplated. For example, instead of the point-to-point architecture of FIG. 17, a system may implement a multi-drop bus or another such communication topology. Also, the elements of FIG. 17 may alternatively be partitioned using more or fewer integrated chips than shown in FIG. 17.

### Additional Notes and Examples

Example 1 includes a computing system comprising a compute-in-memory array to execute computations and store data associated with a workload, and logic coupled to one or more substrates, where the logic is implemented at least partly in one or more of configurable logic or fixed-functionality hardware logic, the logic coupled to the one or more substrates to identify workload numbers associated with the workload, convert the workload numbers to block floating point numbers based on a division of mantissas of the workload numbers into sub-words, and execute a compute-in memory operation based on the sub-words to generate partial products.

Example 2 includes the computing system of Example 1, where to convert the workload numbers to block floating point numbers, the logic coupled to the one or more substrates is to append sign bits of the workload numbers to the sub-words.

Example 3 includes the computing system of Example 1, where to convert the workload numbers to block floating point numbers, the logic coupled to the one or more substrates is to identify a maximum exponent value from exponents of the workload numbers, identify a lower exponent value from the exponents that is smaller than the maximum exponent value, and identify an adjustment to the lower exponent value to adjust the lower exponent value to be equal to the maximum exponent value.

Example 4 includes the computing system of Example 3, where to identify the adjustment to the lower exponent value, the logic coupled to the one or more substrates is to subtract the lower exponent value from the maximum exponent value to identify a difference.

Example 5 includes the computing system of Example 4, where to convert the workload numbers to block floating point numbers, the logic coupled to the one or more substrates is to identify a lower mantissa from the mantissas that is associated with the lower exponent value, and right shift the lower mantissa based on the difference.

Example 6 includes the computing system of Example 3, where the logic coupled to the one or more substrates is to accumulate the partial products to generate an accumulated mantissa, renormalize the accumulated mantissa to generate a final mantissa by a left-shift of the accumulated mantissa a number of times until a largest magnitude bit of the accumulated mantissa has a predetermined value, determine a final exponent based on an exponent value associated with the partial products, the maximum exponent value and the number of times, and associate the final exponent with the final mantissa to generate a final output.

Example 7 includes the computing system of Example 1, where the partial products include a first partial product and a second partial product, where the logic coupled to the one or more substrates is to accumulate a most significant bit of the first partial product with a least significant bit of the second partial product during accumulation of the first partial product and the second partial product, where the workload numbers include extended fixed-point numbers or floating point numbers.

Example 8 includes A semiconductor apparatus comprising one or more substrates, and logic coupled to the one or more substrates, where the logic is implemented at least partly in one or more of configurable logic or fixed-functionality hardware logic, the logic coupled to the one or more substrates to identify workload numbers associated with a workload, convert the workload numbers to block floating point numbers based on a division of mantissas of the workload numbers into sub-words, and execute a compute-in memory operation based on the sub-words to generate partial products.

Example 9 includes the apparatus of Example 8, where to convert the workload numbers to block floating point numbers, the logic coupled to the one or more substrates is to append sign bits of the workload numbers to the sub-words.

Example 10 includes the apparatus of Example 8, where to convert the workload numbers to block floating point numbers, the logic coupled to the one or more substrates is to identify a maximum exponent value from exponents of the workload numbers, identify a lower exponent value from the exponents that is smaller than the maximum exponent value, and identify an adjustment to the lower exponent value to adjust the lower exponent value to be equal to the maximum exponent value.

Example 11 includes the apparatus of Example 10, where to identify the adjustment to the lower exponent value, the logic coupled to the one or more substrates is to subtract the lower exponent value from the maximum exponent value to identify a difference.

Example 12 includes the apparatus of Example 11, where to convert the workload numbers to block floating point numbers, the logic coupled to the one or more substrates is to identify a lower mantissa from the mantissas that is associated with the lower exponent value, and right shift the lower mantissa based on the difference.

Example 13 includes the apparatus of Example 10, where the logic coupled to the one or more substrates is to accumulate the partial products to generate an accumulated mantissa, renormalize the accumulated mantissa to generate a final mantissa by a left-shift of the accumulated mantissa a number of times until a largest magnitude bit of the accumulated mantissa has a predetermined value, determine a final exponent based on an exponent value associated with the partial products, the maximum exponent value and the number of times, and associate the final exponent with the final mantissa to generate a final output.

Example 14 includes the apparatus of Example 8, where the partial products include a first partial product and a second partial product, where the logic coupled to the one or more substrates is to accumulate a most significant bit of the first partial product with a least significant bit of the second partial product during accumulation of the first partial product and the second partial product, where the workload numbers include extended fixed-point numbers or floating point numbers.

Example 15 includes the apparatus of Example 8, where the logic coupled to the one or more substrates includes transistor channel regions that are positioned within the one or more substrates.

Example 16 includes a method comprising identifying workload numbers associated with a workload, converting the workload numbers to block floating point numbers based on a division of mantissas of the workload numbers into sub-words, and executing a compute-in memory operation based on the sub-words to generate partial products.

Example 17 includes the method of Example 16, where the converting the workload numbers to block floating point numbers comprises appending sign bits of the workload numbers to the sub-words.

Example 18 includes the method of Example 16, where the converting the workload numbers to block floating point numbers comprises identifying a maximum exponent value from exponents of the workload numbers, identifying a lower exponent value from the exponents that is smaller than the maximum exponent value, and identifying an adjustment to the lower exponent value to adjust the lower exponent value to be equal to the maximum exponent value.

Example 19 includes the method of Example 18, where the identifying the adjustment to the lower exponent value, includes subtracting the lower exponent value from the maximum exponent value to identify a difference, and where the converting the workload numbers to block floating point numbers comprises identifying a lower mantissa from the mantissas that is associated with the lower exponent value, and right shifting the lower mantissa based on the difference.

Example 20 includes the method of Example 18, where the partial products include a first partial product and a second partial product, and further where the method further comprises accumulating the partial products to generate an accumulated mantissa, renormalizing the accumulated mantissa to generate a final mantissa by a left-shift of the accumulated mantissa a number of times until a largest magnitude bit of the accumulated mantissa has a predetermined value, determining a final exponent based on an exponent value associated with the partial products, the maximum exponent value and the number of times, associating the final exponent with the final mantissa to generate a final output, and accumulating a most significant bit of the first partial product with a least significant bit of the second partial product during accumulation of the first partial product and the second partial product, where the workload numbers include extended fixed-point numbers or floating point numbers.

Example 21 includes an apparatus comprising means for identifying workload numbers associated with a workload, means for converting the workload numbers to block floating point numbers based on a division of mantissas of the workload numbers into sub-words, and means for executing a compute-in memory operation based on the sub-words to generate partial products.

Example 22 includes the apparatus of Example 21, where the means for converting the workload numbers to block floating point numbers comprises means for appending sign bits of the workload numbers to the sub-words.

Example 23 includes the apparatus of Example 21, where the means for converting the workload numbers to block floating point numbers comprises means for identifying a maximum exponent value from exponents of the workload numbers, means for identifying a lower exponent value from the exponents that is smaller than the maximum exponent value, and means for identifying an adjustment to the lower exponent value to adjust the lower exponent value to be equal to the maximum exponent value.

Example 24 includes the apparatus of Example 23, where the means for identifying the adjustment to the lower exponent value, includes means for subtracting the lower exponent value from the maximum exponent value to identify a difference, and where the means for converting the workload numbers to block floating point numbers comprises means for identifying a lower mantissa from the mantissas that is associated with the lower exponent value, and right shifting the lower mantissa based on the difference.

Example 25 includes the apparatus of Example 23, where the partial products include a first partial product and a second partial product, and further where the apparatus further comprises means for accumulating the partial products to generate an accumulated mantissa, means for renormalizing the accumulated mantissa to generate a final mantissa by a left-shift of the accumulated mantissa a number of times until a largest magnitude bit of the accumulated mantissa has a predetermined value, means for determining a final exponent based on an exponent value associated with the partial products, the maximum exponent value and the number of times, means for associating the final exponent with the final mantissa to generate a final output, and means for accumulating a most significant bit of the first partial product with a least significant bit of the second partial product during accumulation of the first partial product and the second partial product, where the workload numbers include extended fixed-point numbers or floating point numbers.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical, or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a compute-in-memory array to execute computations and store data associated with a workload; and
logic coupled to one or more substrates, wherein the logic is implemented at least partly in one or more of configurable logic or fixed-functionality hardware logic, the logic coupled to the one or more substrates to:
identify workload numbers associated with the workload,
convert the workload numbers to block floating point numbers based on a division of mantissas of the workload numbers into sub-words, and
execute a compute-in memory operation based on the sub-words to generate partial products.

2. The computing system of claim 1, wherein to convert the workload numbers to block floating point numbers, the logic coupled to the one or more substrates is to:
append sign bits of the workload numbers to the sub-words.

3. The computing system of claim 1, wherein to convert the workload numbers to block floating point numbers, the logic coupled to the one or more substrates is to:
identify a maximum exponent value from exponents of the workload numbers;
identify a lower exponent value from the exponents that is smaller than the maximum exponent value; and
identify an adjustment to the lower exponent value to adjust the lower exponent value to be equal to the maximum exponent value.

4. The computing system of claim 3, wherein to identify the adjustment to the lower exponent value, the logic coupled to the one or more substrates is to:
subtract the lower exponent value from the maximum exponent value to identify a difference.

5. The computing system of claim 4, wherein to convert the workload numbers to block floating point numbers, the logic coupled to the one or more substrates is to:
identify a lower mantissa from the mantissas that is associated with the lower exponent value; and
right shift the lower mantissa based on the difference.

6. The computing system of claim 3, wherein the logic coupled to the one or more substrates is to:
accumulate the partial products to generate an accumulated mantissa;
renormalize the accumulated mantissa to generate a final mantissa by a left-shift of the accumulated mantissa a number of times until a largest magnitude bit of the accumulated mantissa has a predetermined value;
determine a final exponent based on an exponent value associated with the partial products, the maximum exponent value and the number of times; and
associate the final exponent with the final mantissa to generate a final output.

7. The computing system of claim 1, wherein the partial products include a first partial product and a second partial product,
wherein the logic coupled to the one or more substrates is to:
accumulate a most significant bit of the first partial product with a least significant bit of the second partial product during accumulation of the first partial product and the second partial product,
wherein the workload numbers include extended fixed-point numbers or floating point numbers.

8. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
identify workload numbers associated with a workload,
convert the workload numbers to block floating point numbers based on a division of mantissas of the workload numbers into sub-words, and
execute a compute-in memory operation based on the sub-words to generate partial products.

9. The apparatus of claim 8, wherein to convert the workload numbers to block floating point numbers, the logic coupled to the one or more substrates is to:
append sign bits of the workload numbers to the sub-words.

10. The apparatus of claim 8, wherein to convert the workload numbers to block floating point numbers, the logic coupled to the one or more substrates is to:
identify a maximum exponent value from exponents of the workload numbers;
identify a lower exponent value from the exponents that is smaller than the maximum exponent value; and
identify an adjustment to the lower exponent value to adjust the lower exponent value to be equal to the maximum exponent value.

11. The apparatus of claim 10, wherein to identify the adjustment to the lower exponent value, the logic coupled to the one or more substrates is to:
subtract the lower exponent value from the maximum exponent value to identify a difference.

12. The apparatus of claim 11, wherein to convert the workload numbers to block floating point numbers, the logic coupled to the one or more substrates is to:
identify a lower mantissa from the mantissas that is associated with the lower exponent value; and
right shift the lower mantissa based on the difference.

13. The apparatus of claim 10, wherein the logic coupled to the one or more substrates is to:
accumulate the partial products to generate an accumulated mantissa;
renormalize the accumulated mantissa to generate a final mantissa by a left-shift of the accumulated mantissa a number of times until a largest magnitude bit of the accumulated mantissa has a predetermined value;
determine a final exponent based on an exponent value associated with the partial products, the maximum exponent value and the number of times; and
associate the final exponent with the final mantissa to generate a final output.

14. The apparatus of claim 8, wherein the partial products include a first partial product and a second partial product,
wherein the logic coupled to the one or more substrates is to:
accumulate a most significant bit of the first partial product with a least significant bit of the second partial product during accumulation of the first partial product and the second partial product,
wherein the workload numbers include extended fixed-point numbers or floating point numbers.

15. The apparatus of claim 8, wherein the logic coupled to the one or more substrates includes transistor channel regions that are positioned within the one or more substrates.

16. A method comprising:
identifying workload numbers associated with a workload;
converting the workload numbers to block floating point numbers based on a division of mantissas of the workload numbers into sub-words; and
executing a compute-in memory operation based on the sub-words to generate partial products.

17. The method of claim 16, wherein the converting the workload numbers to block floating point numbers comprises:
appending sign bits of the workload numbers to the sub-words.

18. The method of claim 16, wherein the converting the workload numbers to block floating point numbers comprises:
identifying a maximum exponent value from exponents of the workload numbers;
identifying a lower exponent value from the exponents that is smaller than the maximum exponent value; and
identifying an adjustment to the lower exponent value to adjust the lower exponent value to be equal to the maximum exponent value.

19. The method of claim 18,
wherein the identifying the adjustment to the lower exponent value, includes subtracting the lower exponent value from the maximum exponent value to identify a difference; and
wherein the converting the workload numbers to block floating point numbers comprises:
identifying a lower mantissa from the mantissas that is associated with the lower exponent value, and
right shifting the lower mantissa based on the difference.

20. The method of claim 18, wherein the partial products include a first partial product and a second partial product, and further wherein the method further comprises:
accumulating the partial products to generate an accumulated mantissa;
renormalizing the accumulated mantissa to generate a final mantissa by a left-shift of the accumulated mantissa a number of times until a largest magnitude bit of the accumulated mantissa has a predetermined value;
determining a final exponent based on an exponent value associated with the partial products, the maximum exponent value and the number of times;
associating the final exponent with the final mantissa to generate a final output; and
accumulating a most significant bit of the first partial product with a least significant bit of the second partial product during accumulation of the first partial product and the second partial product,
wherein the workload numbers include extended fixed-point numbers or floating point numbers.
